(19) United States
(12) Patent Application Publication
(10) Pub. No.: US 2007/0205744 A1
(43) Pub. Date: Sep. 6, 2007

(54) Portable mobile phone charger

(75) Inventor: Curtis Corbins, DeSoto, TX (US)

Correspondence Address: ARENT FOX PLLC, 1050 CONNECTICUT AVENUE, N.W., SUITE 400, WASHINGTON, DC, 20036, US

(73) Assignee: AUSTIN DIVERSIFIED PRODUCTS

(21) Appl. No.: 11/797,259

(22) Filed: May 2, 2007

Related U.S. Application Data
(63) Continuation of application No. 10/736,549, filed on Dec. 17, 2003, now abandoned.

(51) Int. Cl. H02J 7/00

(52) U.S. Cl. 320/103

(57) ABSTRACT

A mobile phone charger for charging a mobile phone through a power cord adapter. The mobile phone charger includes a housing unit which has a receptacle mounted therein for receiving the power cord adapter. A power source placed in the housing unit is electrically connected to the receptacle to electrically charge the mobile phone.

### BACKGROUND OF THE INVENTION

1. Field of the Invention

The present invention generally relates to a power backup unit for mobile phones. More specifically, the present invention relates to a battery-based power pack for charging or powering a mobile handset via a power cord adapter.

2. Description of Related Art

There are many ways to power a mobile phone. For instance, the mobile phone can be powered by batteries or power cord adapters attached or connected therewith. One type of the power cord adapters is a cigarette lighter adapter which is a simple and practical way to power or charge the mobile phone when operating an automobile.

However, often the mobile phone is disabled or not functional due to a flat cellular battery or lack of available power outlets. For instance, a mobile phone user may not be able to use his or her phone when traveling in airports, riding in taxi cabs, or walking on city streets when the mobile phone battery is flat or has a low capacity.

Accordingly, there is a need for a portable mobile phone charger that can charge or power the mobile phone anywhere at anytime without scrambling for electrical outlets, being confined by wires, or caught by flat cellular batteries. Moreover, due to different types of mobile phones provided by different mobile phone service providers, there is also a long felt need for a portable mobile phone charger that can universally charge or power all types of mobile phones.

### BRIEF SUMMARY OF THE INVENTION

It is an object of the present invention to satisfy the needs in the above-described related art.

It is another object of the prevent invention to provide a portable power backup unit that conveniently provides battery-based power to a mobile phone.

It is still another object of the prevent invention to provide a portable power backup unit that conveniently charges a mobile phone through a cigarette lighter adapter.

One example for achieving the above object is to provide a mobile phone charger that includes a housing with a receptacle mounted therein for receiving a power cord adapter, and a power source housed therein and electrically connected to the receptacle for electrically charging a mobile phone.

### BRIEF DESCRIPTION OF THE DRAWINGS

The above and other objects and attendant advantages of the present invention will become readily apparent by reference to the following detailed description when considered in conjunction with the accompanying drawings wherein:

FIG. 1 is a front view of a combined mobile phone, power cord adapter, and portable mobile phone charger in accordance with the present invention;

FIG. 2 is a front elevation view of the portable mobile phone charger in accordance with the present invention;

FIG. 3 is a rear elevation view of the portable mobile phone charger of FIG. 2;

FIG. 4 is a perspective front view of the portable mobile phone charger of FIG. 2; and

FIG. 5 is a top plan view showing interior sides of the portable mobile phone charger depicted in FIG. 2.

### DETAILED DESCRIPTION OF THE EXEMPLARY EMBODIMENT

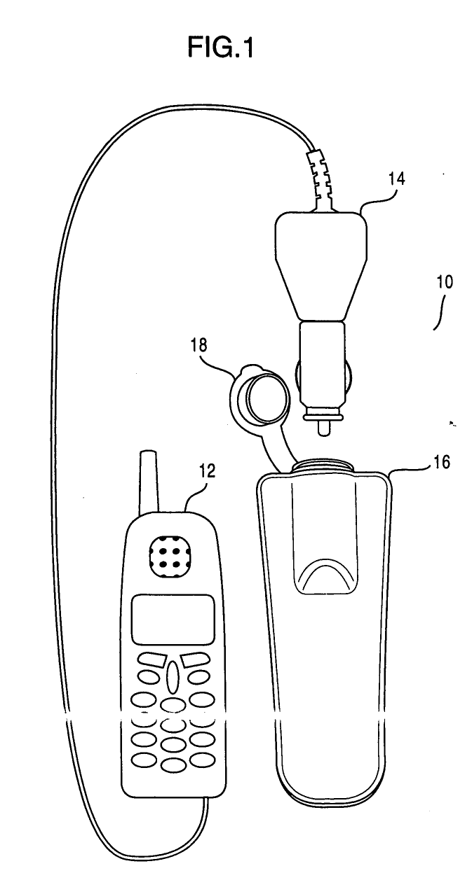

Referring to FIG. 1, depicted therein is a mobile phone charger assembly 10 that includes a mobile phone unit 12 attached to a cigarette lighter adapter 14, which is to be coupled to a portable mobile phone charger 16. The mobile phone charger 16 is constructed in accordance with, and embodying, the principles of the present invention.

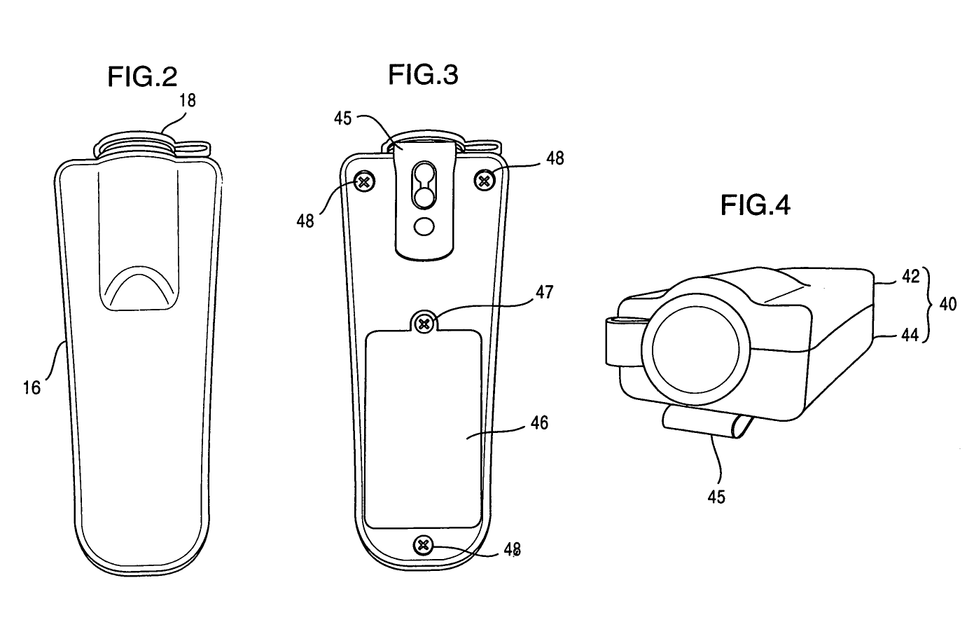

More specifically, the exemplary mobile phone 12 can be any cellular telephone of a particular type, and the exemplary cigarette lighter adapter 14 can be of any type that is compatible with the particular cellular telephone. The exemplary mobile phone charger 16 as shown in FIGS. 1 and 2 includes a protective cap 18, which can be set at an open or closed position. When the cap is set at the open position, the cigarette lighter adapter 14 may engage with the mobile phone charger 16 (FIG. 1). The cap can also seal the mobile phone charger 16 when the cap is manually set at a closed position after the cigarette lighter adapter 14 is detached from the charger (FIG. 2). The cap is consisted of a hollow disk portion and a circular flange portion interconnected by an elongated arm portion, and can be made from a flexible material such as rubber.

Referring to FIGS. 2-4, the portable mobile phone charger 16 includes a protective housing 40 which is comprised of a pair of front and rear panels 42 and 44. The rear panel 44, which has the belt clip 45 attached thereto by way of, e.g., a short screw (not shown), is constructed at a greater depth than the front panel 42. The rear panel 44 also has an opening that is covered by a removable plate 46. A short mounting screw 47 is used to secure the removable plate 46 to the rear panel 44. Due to the different depths, the front panel 42 has a contoured outer surface while the rear panel 44 has a flat outer surface. The front and rear panels are assembled by engaging a groove formed at the open side of the front panel 42 to a flange formed at the open side of the rear panel 44, and tightened via a plurality of mounting screws 48.

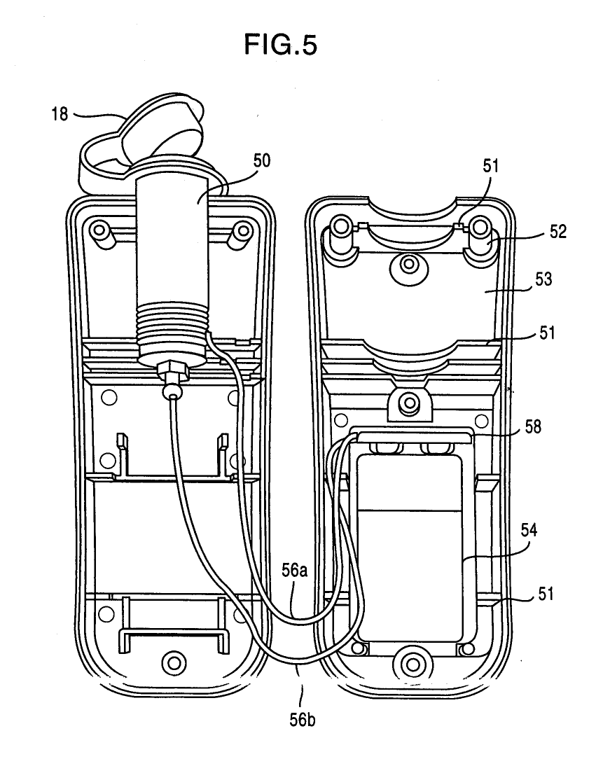

Referring to FIG. 5, the interior of the portable mobile phone charger are shown. Mounted on one end of the charger 16 is a cigarette lighter adapter receptacle 50 with an access portion at one end for receiving the cigarette lighter adapter, and a charge portion at the other end for electrical connection to a DC power source. The hollow disk portion of the cap is attached to the receptacle 50 near the access portion.

The housing has partition walls 51 that include hollow cylindrical columns 52 for receiving the mounting screws. The partition walls also define various recesses 53. Particularly, the recesses in the lower part of the housing form a battery chamber in which a DC power source 54 such as a 9-volt battery is housed. The recesses in the upper part of the housing form a receptacle chamber for housing the cigarette lighter adaptor receptacle 50. A foam (not shown) may be inserted in the battery compartment to provide additional support for the DC power source, which is electrically connected to the cigarette lighter adapter receptacle by a pair electrical wires 56a and 56b. A male/female snap-on connector 58 is used to interface the electrical wires to the DC power source 54 (i.e., 9-volt battery).

It can be appreciated from the above description that the mobile phone charger of the present invention is compact and convenient to carry around. Additionally, working in conjunction with the appropriate cigarette lighter adapter, it can adapt to support various types of mobile phones.

While the invention has been described as being for charging a mobile or cellular phone, it will be understood that the invention could be applied to other uses as well. For example, the portable phone charge may be suitable for charging a Personal Digital Assistant (PDA) or a Global Positioning System (GPS) via cigarette lighter adapter as well.

It will be apparent to those skilled in the art that various modifications, substitutions and changes can be made in the present invention without departing from the spirit or scope of the invention. Thus, it is intended that the present invention cover these modification substitutions and changes provided that they come within the scope of the appended claims and their equivalents.

1. A mobile phone charger for charging a mobile phone through a power cord adapter, comprising:
a housing unit;
a receptacle disposed in said housing unit for receiving said power cord adapter, wherein the power cord adapter is a cigarette lighter adapter; and
a power source disposed in said housing unit and electrically connected to said receptacle for electrically charging said mobile phone, wherein a longitudinal axis of said cigarette lighter adapter and said power source are coaxial relative to each other when said cigarette lighter adapter is connected to said housing unit.

2. The mobile phone charger of claim 1, wherein said housing unit includes a protective cap for sealing said receptacle when said power cord adapter is detached from said receptacle.

3. The mobile phone charger of claim 2, wherein said housing unit further comprises a front panel and a rear panel, said front and back panels each having partition walls to define a first chamber for housing said power source, and a second chamber for housing said receptacle.

4. The mobile phone charger of claim 3, wherein said front and back panels are secured by a plurality of screws, and said receptacle and electrically connected to said power source via a pair of electrical wires.

5. The mobile phone charger of claim 3, wherein said rear panel is of a greater depth than said front panel.

6. The mobile phone charger of claim 3, wherein a belt clip is attached to said rear panel.

7. The mobile phone charger of claim 2, wherein said protective cap is coupled to said receptacle.

8. The mobile phone charger of claim 3, wherein said front panel has a contoured outer surface and said rear panel has a flat outer surface.

9. A mobile phone charger for charging a mobile phone through a power cord adapter, comprising:
a housing unit that includes a front panel and a rear panel;
a receptacle disposed in said housing unit for receiving said power cord adapter, wherein the power cord adapter is a cigarette lighter adapter; and
a power source disposed in said housing unit and electrically connected to said receptacle for electrically charging said mobile phone, wherein a longitudinal axis of said cigarette lighter adapter and said power source are coaxial relative to each other when said cigarette lighter adapter is connected to said housing unit,
wherein said front and back panels each has partition walls to define a first chamber for housing said power source, and a second chamber for housing said receptacle.

10. The mobile phone charger of claim 9, wherein said housing unit further includes a protective cap for sealing said receptacle when said power cord adapter is detached from said receptacle.

11. The mobile phone charger of claim 9, wherein said front and back panels are secured by a plurality of screws, and said receptacle and electrically connected to said power source via a pair of electrical wires.

12. The mobile phone charger of claim 9, wherein said rear panel is of a greater depth than said front panel.

13. The mobile phone charger of claim 9, wherein a belt clip is attached to said rear panel.

14. The mobile phone charger of claim 10, wherein said protective cap is coupled to said receptacle.

15. The mobile phone charger of claim 9, wherein said front panel has a contoured outer surface and said rear panel has a flat outer surface.

16-17. (canceled)
